(19) United States
(12) Patent Application Publication
(10) Pub. No.: US 2010/0050871 A1
(43) Pub. Date: Mar. 4, 2010

(54) Air-Jacketed Coalescer Media with Improved Performance

(75) Inventors: Jerald J. Moy, Oregon, WI (US); Barry M. Verdegan, Stoughton, WI (US); Saru Dawar, Madison, WI (US); Stephen L. Fallon, Oregon, WI (US); Daniel R. Cady, Vancouver, WA (US)

Correspondence Address: ANDRUS, SCEALES, STARKE & SAWALL, LLP, 100 EAST WISCONSIN AVENUE, SUITE 1100, MILWAUKEE, WI, 53202, US

(73) Assignee: Cummins Filtration IP Inc., Minneapolis, MN (US)

(21) Appl. No.: 12/553,502

(22) Filed: Sep. 3, 2009

Related U.S. Application Data
(60) Provisional application No. 61/093,831, filed on Sep. 3, 2008.

(51) Int. Cl. B01D 39/14; F02M 35/024; B01D 46/00; B01D 39/16; B29C 71/00

(52) U.S. Cl. 95/273; 210/489; 55/488; 264/340

(57) ABSTRACT

Disclosed is coalescing media for coalescing a mixture of two phases, namely a continuous phase and a dispersed liquid phase. The media includes polymeric base material having a surface with asperities, and the surface is heterogenous with respect to hydrophilicity/hydrophobicity. The media is configured for coalescing a dispersed liquid phase in a continuous phase where a preponderance of the heterogeneous surface is non-wetting with respect to the dispersed liquid phase. The media is configured for capturing droplets of the dispersed liquid phase where a layer of air is trapped at the heterogeneous surface and tips of the asperities extend through the trapped layer and contact the droplets.

### CROSS-REFERENCE TO RELATED APPLICATIONS

The present application claims the benefit under 35 U.S.C. §119(e) to U.S. Provisional Application No. 61/093,831, filed on Sep. 3, 2008, the content of which is incorporated herein by reference in its entirety.

### BACKGROUND

The field of the invention relates to coalescing media, coalescing systems, and methods for coalescing a mixture of two phases, namely a continuous phase and a dispersed phase. In particular, the field relates to coalescing media, coalescing systems, and methods for coalescing drops of the dispersed phase in order to collect and remove the dispersed phase from the mixture.

In certain aspects, this disclosure describes coalescer media. The coalescer media possesses a thin air film or layer adjacent to the media surface that substantially separates dispersed phase (oil or water) from the solid media surface and facilitates coalescence and drainage of dispersed phase from the media. The thin air film is the result of surface roughness, surface heterogeneity, contact angle, and wettability characteristics that maintain separation of the dispersed phase from the solid surface under operating conditions.

Coalescers are used to separate two immiscible fluids, such as to remove oil mist from gas streams or water droplets from fuel. In crankcase ventilation applications, very high droplet removal efficiencies are required to protect the environment (in open crankcase ventilation applications) and to protect the turbocharger (in closed crankcase ventilation applications). In addition, low restriction or pressure drop is desirable: (1) to avoid the buildup of excessive pressures in the crankcase, (2) to reduce opening of a bypass valve and the resultant decrease in droplet removal, and (3) to extend the service interval of the coalescer. In general, there is a tradeoff between removal efficiency, pressure drop and life. It is desirable to obtain more desirable tradeoffs, i.e., to obtain a more desirable aggregate level of high efficiency, low pressure drop, and increased filter life.

Coalescers are used widely to remove immiscible droplets from a gaseous or liquid continuous phase, such as in crankcase ventilation filtration, fuel water separation, and oil-water separation. Prior art coalescer designs incorporate the principles of enhanced droplet capture and coalescence by utilizing graded capture (i.e., decreasing fiber diameter, pore size and/or porosity in coalescing media) or by utilizing thick depth coalescers. Often, prior art coalescing media may have a more open layer upstream of an interior layer in order to increase life of the coalescer or downstream of an interior layer to increase the size of released drops. Wettability also is recognized as affecting coalescer performance. (See, e.g., U.S. Pat. No. 6,767,459 and U.S published Patent Application Nos. 2007-0131235 and 2007-0062887). U.S. Pat. No. 5,443,724 discloses that the media should have a surface energy greater than water in order to improve coalescer performance (i.e., that the media should be preferentially wetted by both coalescing droplets and continuous phases). U.S. Pat. No. 4,081,373 discloses that coalescing media should be hydrophobic in order to remove water from fuel. U.S. published Patent Application No. 2006-0242933 discloses an oil-mist coalescer in which the filtration media is oleophobic, thereby enabling the fluid mist to coalesce into droplets and drain from the filtration media. This published application also discloses that a second media layer optionally may be hydrophobic.

Improved coalescer media for use in coalescing a dispersed phase from a continuous phase is desirable. Here, an air-jacketed coalescer media is described which exhibits desirable properties with respect to drainage of the dispersed phase, reduced pressure drop, and increased removal of the dispersed phase.

### SUMMARY

Disclosed are coalescer media with unique surface properties and methods of producing coalescer media. In contrast to existing coalescer media, the disclosed coalescer media creates a thin air film or layer adjacent to the media surface to physically separate and substantially separate the dispersed phase (oil or water) from the base media surface in order to facilitate coalescence and drainage of the dispersed phase from the coalescer. Existing coalescer media depend on intimate contact between captured dispersed phase and the coalescer media surface. For crankcase ventilation applications, the dispersed phase may be condensed hydrocarbons, oil, water or a mixture of these.

The disclosed coalescing media may be utilized for coalescing a mixture of two phases, namely a continuous phase and a dispersed phase. The disclosed media may be utilized in coalescers, systems, and methods in order to collect and remove the dispersed phase from the mixture. The continuous phase may include a continuous gas phase or a continuous liquid phase. The dispersed phase may include a dispersed liquid phase.

The disclosed coalescers, coalescing systems, and methods may be utilized to coalesce any suitable mixture that includes a continuous phase and a dispersed phase. In some embodiments, the continuous phase is a gas and the dispersed phase is a liquid. For example, the disclosed systems and methods may be configured or utilized for coalescing droplets of hydrocarbon liquid (e.g., hydrocarbon fuel, biodiesel fuel, or lubricating, hydraulic, or transmission oil), water, or a mixture of these from a gas stream.

In some embodiments, the disclosed coalescing media may be configured for use in a coalescer, a coalescing system, or a coalescing method. The disclosed coalescers, coalescing systems, and coalescing methods may include or utilize the disclosed coalescing media for coalescing a dispersed phase from a mixture of the dispersed phase in a continuous phase. Optionally, the coalescers, coalescing systems, and coalescing methods may include or utilize additional media. For example, the disclosed coalescers, coalescing systems, and coalescing methods further may include or further may utilize additional media for removing condensed hydrocarbons, oil, water or a mixture of these, where the additional media is positioned upstream or downstream of the coalescing media.

The disclosed coalescing media may be utilized in coalescers, coalescing systems, and coalescing methods for removing a dispersed phase from a continuous phase. In some embodiments, the coalescing media may be utilized in coalescers, systems, or methods for removing a dispersed phase comprising condensed hydrocarbons, oil, water or a mixture of these. Preferably, the coalescing media may be utilized in coalescers, systems, or methods for removing at least about 93% of a dispersed phase (more preferably at least about 95% of a dispersed phase, even more preferably at least about 97% of a dispersed phase, most preferably at least about 99% of a dispersed phase). In some embodiments of the coalescers, coalescing systems, and coalescing methods, the continuous phase is a gas and the dispersed phase is a liquid (e.g., hydrocarbon liquid, water, or a mixture of these).

In some embodiments, a coalescer or coalescer system as contemplated herein may include the disclosed coalescing media contained in a housing. The housing may include an upstream inlet structured to receive the mixture, a first downstream outlet structured to discharge the mixture after coalescing, and optionally a second downstream outlet structure to discharge the coalesced dispersed phase.

The disclosed media may be utilized in a crankcase filter. Preferably, the crankcase filter exhibits an efficiency greater than 85% with respect to the dispersed phase, and exhibits a final saturated pressure drop of less than about 5 inches of water. More preferably, the crankcase filter exhibits an efficiency greater than 90% with respect to the dispersed phase, and exhibits a final saturated pressure drop of less than about 5 inches of water. Even more preferably, the crankcase filter exhibits an efficiency greater than 95% with respect to the dispersed phase, and exhibits a final saturated pressure drop of less than about 5 inches of water. Ideally, the crankcase filter exhibits an efficiency greater than 99% with respect to the dispersed phase, and exhibits a final saturated pressure drop of less than about 5 inches of water.

### BRIEF DESCRIPTION OF THE DRAWINGS

FIG. 1 is a conceptual illustration of an air-jacketed coalescer media as contemplated herein.

FIG. 2 is a conceptual illustration of the soak test utilizing Media A, B, C, D, E, F, and G.

FIG. 3 graphical illustrates oil mist removal efficiency versus time for Media A and Media B.

FIG. 4 illustrates a method for determining contact angle θ for a dispersed drop on a media phase.

FIG. 5 illustrates determination of θ for a polyester coalescer media.

FIG. 6 illustrates determination of χ for a polyester coalescer media.

FIG. 7 illustrates determination of α. (1) Initial position with media in horizontal position, (2) Media tilted at angle α where drop first begins to move.

FIG. 8 illustrates dynamic contact angle measurement to determine hysteresis.

FIG. 9 illustrates advancing and receding contact angles of oil drops on Media B.

FIG. 10 illustrates surface heterogeneity for two different coalescer media.

### DESCRIPTION OF ILLUSTRATIVE EMBODIMENTS

For purposes of promoting an understanding of the principles of the invention, reference will now be made to the embodiments illustrated in the drawings and specific language will be used to describe the same. It will nevertheless be understood that no limitation of the scope of the invention is thereby intended, any alterations and further modifications in the illustrated device, and such further applications of the principles of the invention as illustrated therein being contemplated as would normally occur to one skilled in the art to which the invention relates.

The coalescing media disclosed herein may be utilized to coalesce droplets of a dispersed phase from a mixture of the dispersed phase in a continuous phase. Mixtures contemplated herein may include mixtures of a hydrophobic liquid (e.g., a hydrocarbon liquid) and an aqueous liquid (e.g., water) dispersed in a gas. In some embodiments, the continuous phase may be a hydrocarbon liquid and the dispersed phase may be water. In other embodiments, the continuous phase may be water and the dispersed phase may be a hydrocarbon liquid. As contemplated herein, a hydrocarbon liquid primarily includes hydrocarbon material, which may include mixtures of different hydrocarbon materials, but further may include non-hydrocarbon material (e.g., up to about 1%, 5%, 10%, or 20% non-hydrocarbon material which may include water).

The coalescing media disclosed herein may be utilized in coalescers, coalescing elements, coalescing filters, coalescing apparatuses, coalescing assemblies, coalescing systems, and coalescing methods disclosed in the art. (See, e.g., U.S. Pat. Nos. 7,416,657; 7,326,266; 7,297,279; 7,235,177; 7,198,718; 6,907,997; 6,811,693; 6,740,358; 6,730,236; 6,605,224; 6,517,615; 6,422,396; 6,419,721; 6,332,987; 6,302,932; 6,149,408; 6,083,380; 6,056,128; 5,874,008; 5,861,087; 5,800,597; 5,762,810; 5,750,024; 5,656,173; 5,643,431; 5,616,244; 5,575,896; 5,565,078; 5,500,132; 5,480,547; 5,480,547; 5,468,385; 5,454,945; 5,454,937; 5,439,588; 5,417,848; 5,401,404; 5,242,604; 5,174,907; 5,156,745; 5,112,498; 5,080,802; 5,068,035; 5,037,454; 5,006,260; 4,888,117; 4,790,947; 4,759,782; 4,643,834; 4,640,781; 4,304,671; 4,251,369; 4,213,863; 4,199,447; 4,083,778; 4,078,965; 4,052,316; 4,039,441; 3,960,719; 3,951,814; and U.S. published Application Nos. 2007-0289915; 2007-0107399; 2007-0062887; 2007-0062886; and 2007-0039865; the contents of which are incorporated herein by reference in their entireties.) The coalescing media disclosed herein may be manufactured utilizing methods known in the art and may include additional features disclosed in the art. (See, e.g., U.S. Pat. Nos. 6,767,459; 5,443,724; and 4,081,373; and U.S published Patent Application Nos. 2007-0131235; 2007-0062887; and 2006-0242933; the contents of which are incorporated herein by reference in their entireties.).

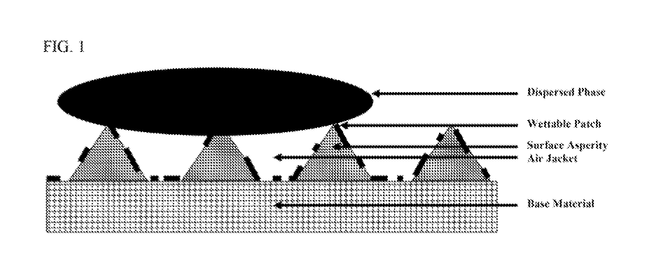

FIG. 1 conceptually illustrates this invention, air-jacketed coalescer media, and the nomenclature that will be used. Air-jacketed coalescer media consists of filter media used to separate dispersed phase droplets from a continuous phase. The base media comprises polymeric fibers, such as polyester, nylon, fluorocarbon polymers, or other polymers. Extending out from the surface of the base media are asperities or projections. Typically, these asperities are organic chains or structures resulting from surface modification processes, such as coating, plasma treatment, or related processes, or resulting from the production of the fibers themselves. At a nanoscale level, these asperities create a roughened surface on the base fibers. This roughened surface, in conjunction with dispersed phase nonwetting areas of the surface, result in depressions, valleys, or pockets along the media surface that hold and trap air between the base media and captured dispersed phase. This trapped air on the surface maintains the spatial separation between the base media and dispersed phase that is important to the function of this invention. Within the space created between the base media and the dispersed phase resting at the distal tips of the asperities, is a thin layer of gas, typically air. The surface of the media, including both the surfaces of the base media and of the asperities that are in contact with the environment may be heterogeneous. Surface heterogeneity refers to the existence of neighboring nanoscale surface patches that differ chemically and in terms of their wettability with respect to the dispersed phase. It is preferable that a portion of the surface be composed of nonwetting regions with respect to the dispersed phase, in order to enhance the performance of the coalescer.

Air-jacketed coalescer media can be distinguished from other coalescer media based on performance in the soak test as described herein. In air, a sample coupon of the media (e.g., a coupon that is 5 cm×2.5 cm wide) is placed in a container, such as a beaker, containing a liquid (e.g., a hydrocarbon liquid such as engine lubricating oil for crankcase ventilation applications). The sample is then submerged by placing a weight on it until air bubbles cease to rise from it. Gentle squeezing or pressing on the submerged media may be used to accelerate the process. The weight is then removed and the relative buoyancy of the sample observed. When the density of the media is greater than the density of the liquid, traditional, non-air-jacketed coalescer media will remain submerged, while air-jacketed coalescer media will float, typically with only a small portion remaining below the surface of the liquid.

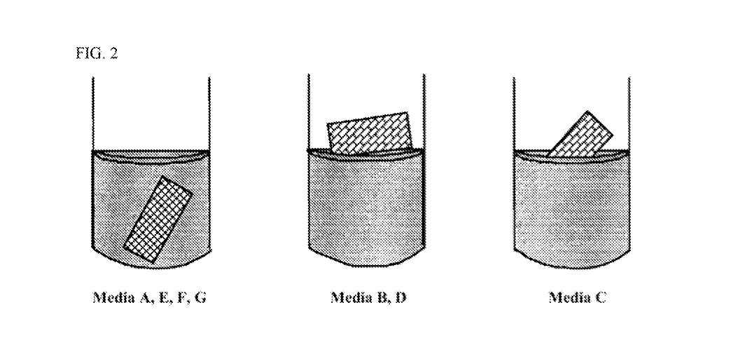

The soak test was conducted on samples of seven different coalescer media, Media A, B, C, D, E, F and G. (See FIG. 2). The dispersed phase liquid was an engine lubricating oil (Citgo Citgard® 500 Motor Oil, SAE 10W30). Media A is a polyester media formed by meltblowing. The density of the media is 1.313 g/cm³. Media B, D, E, F, and G are the same base media as Media A, but received various types of plasma treatments. Related plasma treatments are described in U.S. Pat. Nos. 6,429,671 and 6,419,871. Media C is the same as Media A, but was chemically treated with Rain-X® containing a polydimethylsiloxane. In the soak test, Media A, E, F, and G were quickly wetted by the oil dispersed phase and sank to the bottom of the beaker, indicating that they are not air-jacketed coalescer media. (See FIG. 2). Media B and D retained essentially all of their air upon submersion, and quickly rose to the surface of the oil upon removal of the added weight. They floated almost entirely above the surface of the oil. (See FIG. 2). Similar to Media B and D, Media C retained much of its air upon submersion and rose to the surface of the oil upon removal of the added weight. Although it floated largely above the surface of the oil, it appeared to be somewhat less buoyant than Media B and D. (See FIG. 2). The behaviors of Media B, C, and D are characteristic of air-jacketed coalescer media, which remain buoyant after submersion due to the presence of air trapped in the roughened, relatively nonwetted surface of these treated media. The behaviors of Media A, E, F, and G are characteristic of non-air-jacketed coalescer media. Media C has a less well developed air jacket than Media B and D, but their buoyancy demonstrates that all three possess air jackets as described in this application. To confirm this, the experiment was repeated for Media B, C, and D with the system (beaker, oil, media) under vacuum. In each cases, when the air jacket was stripped from the media by vacuum, the media no longer floated, and rather sank to the bottom of the beaker.

The surface structure of the air jacketed coalescer media that is exposed to fluid is designed or modified to create an air jacket. The surface structure that the media presents to droplets of the captured and/or coalesced dispersed phase is a composite surface comprising an air film or layer. The solid surface of the actual coalescer media is roughened by asperities. The tips of the asperities protrude through the air film or layer. The sides and base of the asperities are primarily nonwetting with respect to the dispersed phase, although the asperities may be heterogeneous having nanoscale patches of nonwetting and wetting areas with respect to the dispersed phase. Droplets of the dispersed phase collect on this composite surface, are loosely held and drain freely, which reduces the pressure drop across the coalescer. The ease of drainage can be experimentally characterized by sine α, where α is the minimum angle of media surface tilt at which a droplet spontaneously moves. The following equation has been devised for calculating sine α for fluorocarbon coated snow- and ice-repellant fabrics:

$$sin α = \frac{2 Rk sin χ ( cos χ + 1 )}{g ( R cos θ + 1 )} \sqrt[3]{\frac{3 {π}^{2}}{{m}^{2} ρ ( 2 - 3 cos χ + {cos}^{3} χ )}}$$

where
R=roughness factor
k=constant
θ=contact angle of the flat media (without asperities)
χ=contact angle of the rough surface with asperities
g=acceleration due to gravity
m=mass of the droplet
ρ=specific gravity of the droplet
   (See Kulinich et al., Vacuum 79 (2005): 255-264). In the equation, R is the ratio of the area of the sides of the asperities to their projected area. The constant k is related to the interaction energy between the surface and liquid. The contact angle θ is the effective contact angle of the media without asperities (flat). For heterogeneous surfaces, it can be considered an area weighted average of the contributions of wetting and nonwetting areas of the surface. The contact angle χ is the equilibrium contact angle of the dispersed phase on the rough media's (including asperities) chemically heterogeneous composite surface including trapped air.

The previous equation is used in the garment and clothing industry. However, here, it has been recognized that the equation can be adapted to coalescer media, such as is used for crankcase ventilation applications. Furthermore, it has been recognized that it is desirable to minimize α, in order to facilitate drainage of dispersed phase from coalescers and reduce their pressure drop. In general, the equation demonstrates that it is desirable to increase R, i.e., the relative height (or protruding distance) of the asperities relative to their base (where they are in contact with the base material); and to increase both θ and χ. Maximizing these characteristics optimizes coalescer performance by increasing the thickness and integrity of the air film between the base material and the dispersed phase. According to filtration theory, maximizing these characteristics should not affect initial contaminant removal, because media fiber diameter, porosity, and thickness are kept constant. However, maximizing the characteristics to the point where the media becomes air-jacketed leads to the creation of an air layer that separates the dispersed phase from the base media surface. Thus, the dispersed phase can only weakly attach to the air-jacketed media and drainage is facilitated.

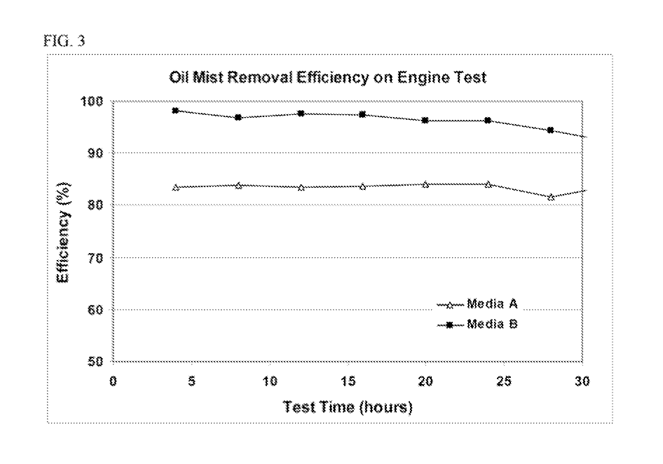

The benefits of air-jacketed media relative to conventional media for crankcase ventilation applications are demonstrated in Table 1 for coalescer elements made from Media A, B, and D, previously described. The new elements using the various coalescer media were tested using a TSI 8127 Automated Filter Tester in order to determine their pressure drop (ΔP) and in order to determine the ability of 0.3 μm oil mist droplets to penetrate the media. The pressure drop and oil mist removal efficiency of the elements were determined after saturating them with oil, to simulate used filters, and then challenging them with an ultrafine oil mist. The gravimetric efficiency of the media is reported. As can be seen from Table 1, the new element pressure drop and penetration for all three media are similar, as is predicted by filtration theory because all three media are physically similar in terms of fiber diameter, porosity, and depth characteristics. However, the saturated element removal efficiency is much higher and pressure drop lower for coalescers using the air-jacketed media, Media B and D, compared to the non-air-jacketed reference Media A. Table 1 shows the results of lab tests. Coalescer elements made from Media A and Media B were further tested as crankcase ventilation filters on an engine running on a dynamometer for 30 hrs. The gravimetric efficiency as a function of time is shown in FIG. 3. Over the 30 hours of operation, Media A yielded an average efficiency of 83.4% while Media B yielded an average efficiency of 96.7%. In both lab and on-engine tests for oil mist removal, air-jacketed media exhibit higher removal than comparable non-air-jacketed coalescer media. This unexpected benefit of the air-jacketed media is not predicted by filtration theory.

TABLE 1
Comparision of Coalescer Performance by Different Coalescer
Media

| | | New | | Saturated | |
|---|---|---|---|---|---|
| | | Element | | Element | |
| | | ΔP | | | Final |
| | | (mm | Penetration | Efficiency | ΔP |
| Media | Description | H2O) | (%) | (%) | (mbar) |
| Media A | reference media | 21.53 | 14.9 | 79.17 | 14.5 |
| Media B | air-jacketed | 19.90 | 12.8 | 99.80 | 10.6 |
| | media | | | | |
| Media D | air-jacketed | 21.35 | 12.1 | 99.47 | 9.7 |
| | media | | | | |

The surface characteristics of air-jacketed coalescer media can be defined more precisely in terms of the desired ranges for the following: θ, χ, normalized sine α, contact angle hysteresis of the media; and/or minimum surface area ratio. These ranges and desired values will now be discussed.

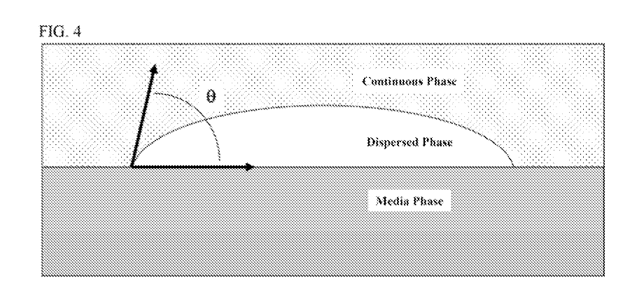

There are various theoretical and experimental means to calculate, estimate and measure θ and χ. In FIGS. 4-6, the meaning and convention used to define contact angle is illustrated. Three-phase contact angle is defined as the angle with its vertex at the intersection of the continuous, dispersed and media phases with one ray extending parallel to the media surface from the vertex and the other ray extending tangentially to the surface of the dispersed phase at the vertex. (See FIG. 4). The angle is measured through the dispersed phase. As shown in the previous equation, there are two different contact angles, θ and χ, referred to here.

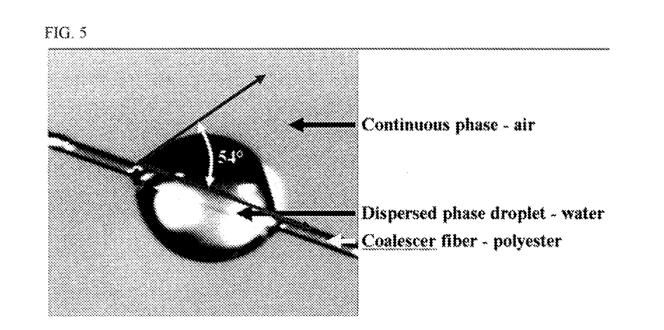

The contact angle θ can be estimated by measuring the contact angle of a droplet on an individual fiber or by procuring a sample of the media in flattened form without asperities. (See FIGS. 4 and 5). FIG. 5 illustrates an oil droplet that was sprayed onto a 20.6 μm diameter fiber of polyester filter media. The contact angle θ was determined from a photomicrograph of the droplet attached to the fiber. However, the contact angle θ can be determined by a variety of means, including by photographing droplets on a fiber; using a goniometer; the tilted plate method; or force balance methods such a Wilhelmy plate method. In the absence of data obtain from flattened media, this is a useful approximation for θ that reflects the surface heterogeneity of the fibers.

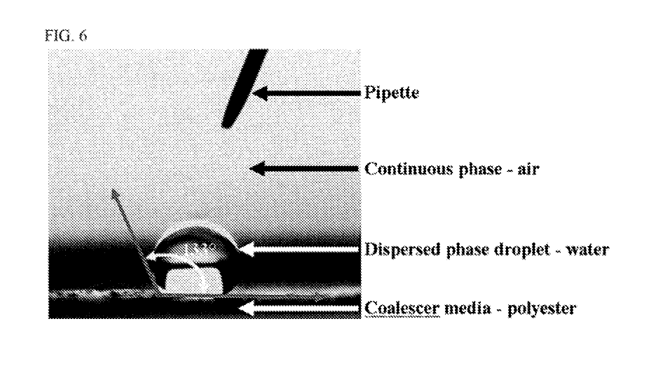

Similarly, χ can be estimated by measuring the contact angle of a dispersed phase drop on a patch of filter media, as shown in FIG. 6. FIG. 4 shows a water drop on a patch of nonwoven polyester filter media. By using a patch of media, as opposed to an individual fiber, the aggregate properties of the media including asperities are better represented.

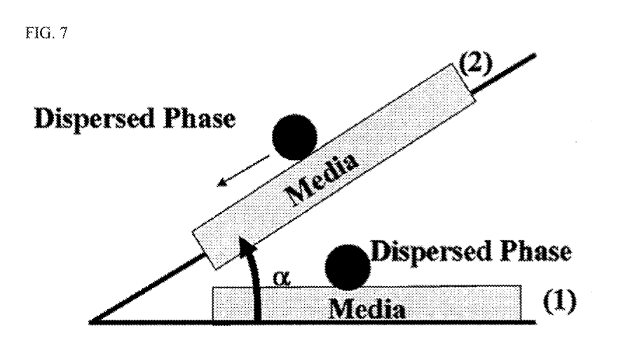

The angle α can be determined directly by placing a drop of dispersed phase on a horizontal sample of coalescer media and gradually changing the tilt or angle of elevation until the drop begins to move, as shown in FIG. 7. The media sample should be relatively smooth (i.e., the fibers should be aligned horizontal initially and essentially none should project out from the horizontal surface). The mass of the drop placed on the media should be determined. The angle α is a characteristic of the coalescer media and is a function of θ, χ and R, as well as the mass and density of the drop and k. For crankcase ventilation applications, the normalized sine α, (i.e., sin αm^{2/3}ρ^{1/3}g) should be less than a critical value for both oil and water.

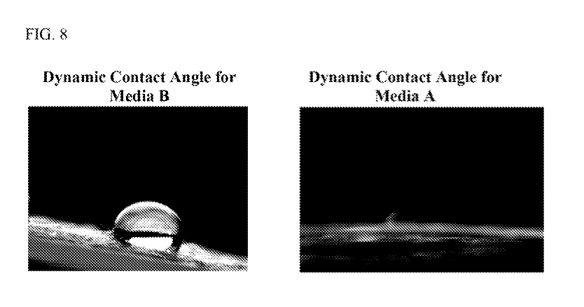

Experiments were conducted on Media A and B to determine their normalized sine α and air retention properties. FIG. 8 shows evidence of surface heterogeneity and roughness for Media A and Media B as described above. Media A (FIG. 8A) is a non-air-jacketed media with χ=0° and θ=34°±19° for oil. Media B (FIG. 8B) is an air-jacketed media with χ=116° and θ=57°±12° for oil. For Media A, oil drops were wicked into the media and no drainage was observed at any tilt angle and the Citgard® 500 oil completely wicked into the media, displacing the air. For Media B, neither water nor oil drops wicked into the media. For oil, drops weighing 0.0213 g started to move at a mean angle α of 48°. Thus, the normalized sine α for this media was 54 g/s². For water drops, the angle α was approximately 78° and the normalized sine α was 82 g/s². Comparison of the results for Media A and Media B suggest that if the normalized sine α for the dispersed phase is less than 72 g/s² and wicking does not occur, the media is air-jacketed. Based on the results, air-jacketed media preferably possess the following characteristics:
A. χ is greater than 60°, and ideally greater than 90°; and θ is greater than 45°, and ideally greater than 90°;
B. normalized sine α is less than 72 g/s² when the dispersed phase is oil and 84 g/s² when the dispersed phase is water; and
C. the media floats when a soak test is conducted on it.

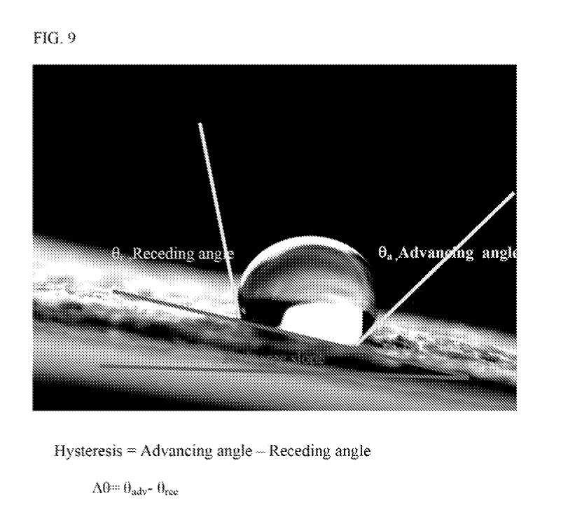

Contact angle hysteresis can also be used to define air-jacketed coalescer media. Contact angle hysteresis may be defined as the difference between the dynamic, advancing and receding, contact angles of the media. Higher contact angle hysteresis is indicative of increased surface roughness and/or surface heterogeneity. Dynamic contact angle measurements were performed by determining the advancing and receding contact angles on the surface of the media at a tilted angle of 20°, as shown in FIG. 9. Dynamic contact angle measurements were done in this manner for Media A, Media B, Media E and Media F using oil drops. The results, shown in FIG. 8 and summarized in Table 2, show that the air-jacketed Media B exhibits both advancing and receding contact angles greater than 90°, compared to advancing and receding contact angles less than 90° for Media A, Media E and Media F. Further, Media B exhibits greater hysteresis than non-air-jacketed Media A, Media E and Media F. The increase in the hysteresis for the air-jacketed media is due to the increase in the surface roughness and heterogeneity. This, coupled with the greater nonwetting character of the media with respect to the oil drops, as indicated by the advancing, receding and static contact angles of Media B, gives rise to the air jacket surrounding the media. This shows that air-jacketed coalescer media exhibit advancing and receding contact angles greater than 90° and hysteresis, greater than 5°, preferably greater than 10°.

TABLE 2
Contact Angle Hysteresis for Oil Drops on Different Coalescer
Media

| | | Contact Angle | | |
|---|---|---|---|---|
| | | Advancing | Receding | Hysteresis |
| Media | Description | (°) | (°) | (°) |
| Media A | reference media | 0 | 0 | 0 |
| Media B | air-jacketed media | 111 | 98 | 13 |
| Media E | Non-air-jacketed media | 0 | 0 | 0 |
| Media F | Non-air-jacketed media | 0 | 0 | 0 |

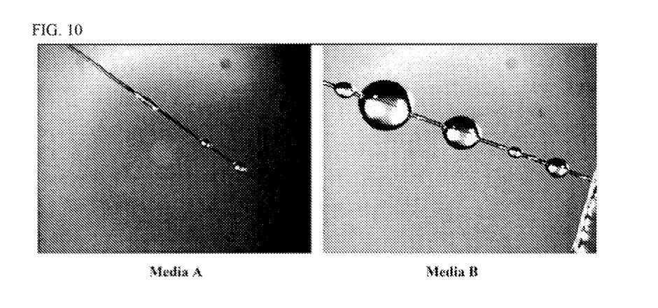

The effects of surface heterogeneity for two different coalescer media is illustrated in FIG. 10. Media A and Media B were compared with respect to their ability to coalesce oil drops. Media B air-jacketed media exhibited superior coalescing properties.

The importance of asperities extending from the base media fibers to create a roughened surface with valleys, pockets, depressions, and cavities in which to trap air may be confirmed by calculating the theoretical surface area of Media A and Media B and comparing it to the measured surface area, as determined by BET surface area measurements. The theoretical surface area per unit mass, A_{T}, of the media was calculated using the following equation:

$${A}_{T} = \frac{2}{R ρ}$$

Where R=mean fiber radius, and
ρ=density of the fiber material.

For Media A and Media B, the theoretical surface area per unit mass is 0.305 m²/g. The measured surface area for Media A was 0.751 m²/g while for Media B it was 0.846 m²/g. Thus, the surface area ratio for Media A was 2.46 and for Media B was 2.77, confirming that air-jacketed media posses greater surface roughness than conventional media and suggests that a surface area ratio exceeding 2.65 is desirable for air-jacketed media.

In some embodiments of the disclosed coalescer media, a combination of base material, asperities, surface heterogeneities, and net dispersed phase nonwetting behavior of the media with respect to the dispersed phase are selected to produce a coalescer media with a retained air jacket on the surface. The coalescer media exhibits improved drainage of the dispersed phase, reduced pressure drop and increased removal. The air-jacketed coalescer media disclosed herein may include filter media, typically made of nonwoven polymeric fibers, with a surface characterized by numerous asperities creating a roughened surface with valleys, depressions, pockets, and cavities, the surfaces of which tend to be nonwetted with respect to the dispersed phase, but may be heterogeneous. The disclosed air-jacketed coalescer media typically floats in a soak test. More specifically, air-jacketed coalescer media exhibits at least one of the following combinations of properties:
1. θ is greater than 45° and, ideally, greater than 90° and χ is greater than 60° and, ideally, greater than 90°;
2. θ is greater than 90° and contact angle hysteresis is greater than 5° and, ideally, greater than 10°;
3. χ is greater than 90° and contact angle hysteresis is greater than 5° and, ideally, greater than 10°;
4. θ is greater than 90° and surface area ratio is greater than 2.65;
5. χ is greater than 90° and surface area ratio is greater than 2.65;
6. normalized sine α is less than 72 g/s² when the dispersed phase is oil; and
7. normalized sine α is less than 84 g/s² when the dispersed phase is water.

The desired properties may be obtained in a variety of ways. The base material is typically polymeric (e.g., polyester, nylon, polypropylene, polyphenylene sulfide, polyurethane, fluorocarbon, or other polymeric material that can be formed into a nonwoven fibrous or other porous structure). The base material may include thermoplastic polymer. The methods described in U.S. Published Application Nos. 2007/0107399 and 20070131235, which are incorporated herein by reference in their entireties disclose methods of producing media with base structure suitable for preparing the air-jacketed coalescer media disclosed herein. Other methods for obtaining suitable media and media structures for preparing the air-jacketed coalescer media disclosed herein include, but are not limited to, wet laying, melt blowing, melt spinning, electro-spinning, and electro-blowing.

There are a variety of methods of producing the desired surface properties of the air-jacketed coalescer media disclosed herein. The following is a non-exhaustive list of methods for achieving the desired surface roughness and wetting properties of the air-jacketed coalescer media:
(1) coating the surface of the media with appropriate additives, such as fluorocarbons, silicones, siloxanes, and the like;
(2) treating the media with fluorocarbon surfactants dissolved in a nonpolar solvent, then removing the solvent;
(3) incorporating additives into the base polymer used to produce the media;
(4) chemically etching the surface of the base media and surface coating the base media with fluorocarbons;
(5) coating the surface of the base media with nanoparticles and treating the resultant media with appropriate additives to impart nonwetting characteristics with respect to the dispersed phase (e.g., fluorocarbons or siloxanes);
(6) vacuum or air plasma treating the base media, for example, using methods disclosed in U.S. Pat. No. 6,419,871 and U.S. Published Application No. 2005/0006303 A1, the contents of which are incorporated by reference herein in their entireties;
(7) spraying or otherwise applying nanoparticles to the base material.

Coalescers are widely used to remove immiscible droplets from a gaseous or liquid continuous phase, such as for crankcase ventilation filtration, fuel water separation, and oil-water separation. It is recognized that wettability with respect to the dispersed phase affects coalescer performance. In particular, different wettability characteristics in different locations within the media may affect performance. (See U.S. Pat. No. 6,767,459 and U.S. Published Application Nos. 20070131235 A1 and 20070062887 A1, the contents of which are incorporated by reference herein in their entireties).

According to certain embodiments, a filtration medium includes a substrate made of a polymer material, where the substrate includes a surface having a roughness and/or micro-protrusions. The micro-protrusions may be particles applied to the surface, artifacts of the polymer fibers protruding from the surface, protrusions due to deposits of a coating, or any other type of protrusions applied by any method understood in the art. The protrusions should be small enough and closely spaced such that a droplet from a dispersed phase should be expected to contact a multiplicity of protrusions before contacting the underlying substrate, and in certain embodiments the averaged droplet from the dispersed phase may not contact the underlying substrate at all. In certain embodiments, the dispersed phase includes condensed hydrocarbons, oil, and/or water.

The surface further preferably includes a wettability patch pattern, where the wettability patch pattern has a nano-scale variability and a wettability character such that a preponderance of an area of the surface is non-wetting to a dispersed phase. In certain embodiments, the surface as viewed from the macroscopic level includes an overall area of greater than 50% that is non-wetting to the dispersed phase. However, localized areas of the surface may be wetting or a majority wetting to the dispersed phase. The term nano-scale variability used herein does not necessarily indicate a scale of nano-meters (m⁻⁹), but rather indicates a scale that is small relative to an average droplet size typically expected to impinge on the surface. For example, if the average droplet size is impinging on the filter media is typically expected to be on the order of 4×10⁻⁵ meters in diameter, the variability of the wettability patch pattern should change on average within a distance much lower than each 4×10⁻⁵ meters.

Wettability may be defined based on the contact angle θ of a drop of the dispersed phase on the surface of the media. For example, the contact angle θ of a drop of the dispersed phase on the surface of a non-wetting media typically is greater than 90° and ideally greater than 120°. The contact angle θ of a drop of the dispersed phase on the surface of a media that is not strongly wetting or non-wetting typically is greater than 60° and less than 120°. The contact angle θ of a drop of the dispersed phase on the surface of a media that is wetting typically is less than 90° and preferably less than 60°. Wettability of the surface of the media is influenced by the hydrophobicity or hydrophilicity of the surface of the media (or alternatively the oleophobicity or oleophilicity of the surface of the media) relative to the liquid dispersed phase. For example, a hydrophilic (or oleophobic) surface will be relatively nonwettable by a hydrophobic (or oleophilic) liquid. Likewise, a hydrophobic (or oleophilic) surface will be relatively nonwettable by a hydrophilic (or oleophobic) liquid.

In certain embodiments, the dispersed phase may include entrained oil droplets and/or hydrocarbon droplets such as found in the vapor of a crankcase. In certain embodiments, the dispersed phase may include water, and/or any type of material as a misted liquid. The present application may apply to any fluid that includes a dilute phase to be separated from a main phase, where the dilute phase is a liquid and/or a phase that becomes liquid upon passing into and through the filter medium. In certain embodiments, it is desirable to have a prior understanding of the wettability characteristics of the dispersed phase, however certain aspects of the present application are beneficial in certain embodiments even where the wettability of the dispersed phase is unknown, poorly known, not well understood, and/or subject to change during the operation of a filter medium constructed in light of the present application.

In certain embodiments, the polymer material comprises a plurality of polymeric fibers selected from the at least one of the polymeric fibers consisting of polyester, nylon, fluorocarbon, polypropylene, polyphenylene sulfide, polyurethane, and an aramid. In certain embodiments, the substrate is constructed by a method such as wet laying, melt blowing, melt spinning, electro-spinning, electro-blowing, and other polymeric substrate construction methods understood in the art.

In certain embodiments, the micro-protrusions cooperate with drops of the dispersed phase to form an interference layer between the droplets of the dispersed phase and the surface. In certain embodiments, the micro-protrusions trap a gas layer between droplets of the dispersed phase and the surface of the media.

In certain embodiments, the wettability patch pattern and the micro-protrusions are formed such that a drop of the dispersed phase settled on the surface forms a first contact angle χ from the surface, wherein χ comprises a value greater than about 60°. In certain embodiments, a stronger wettability patch pattern (e.g. a greater percentage of the bulk surface area is non-wetting, and/or the wettability patch sizes are smaller) increases the angle χ, and a practitioner can test the χ and tune the wettability patch pattern to achieve the desired χ. In certain embodiments, the micro-protrusion density may be increased to increase the angle χ, and a practitioner can tune the micro-protrusion density to achieve the desired angle χ. In certain embodiments, the χ value is greater than about 90°.

In certain embodiments, the polymer material includes polymer fibers, and the wettability patch pattern is formed such that a droplet of the dispersed phase settled on one of the polymeric fibers forms a second contact angle θ, wherein θ comprises a value greater than about 45°. In certain embodiments, a stronger wettability patch pattern increases the angle θ, and a practitioner can test the angle θ and tune the wettability patch pattern to achieve the desired θ. In certain embodiments, θ is a value greater than about 90°.

In certain embodiments, it is desirable that droplets of the dispersed phase flow easily across the substrate. In certain embodiments, the filtration medium exhibits a normalized sine α value lower than a drainability threshold. The normalized sine α value, in certain embodiments, describes quantitatively the ability of droplets to flow across the medium under gravity or other induced forces. In certain embodiments, the normalized sine α (sin αₙₒᵣₘ) is defined as sin αₙₒᵣₘ=sin αm^{2/3}ρ^{1/3}g, where sin α is defined as

$$sin α = \frac{2 Rk sin χ ( cos χ + 1 )}{g ( R cos θ + 1 )} \sqrt[3]{\frac{3 {π}^{2}}{{m}^{2} ρ ( 2 - 3 cos χ + {cos}^{3} χ )}} ,$$

where R is a roughness factor, k is a constant, χ is a first contact angle, θ is a second contact angle, g is acceleration due to gravity, m is a representative droplet mass, and ρ is a representative droplet density. In certain embodiments, the dispersed phase is water and wherein the sin αₙₒᵣₘ is less than about 84 g/s². In certain embodiments, the dispersed phase comprises oil and wherein the sin αₙₒᵣₘ is less than about 72 g/s².

In certain embodiments, the substrate floats at the surface of the liquid dispersed phase. In certain embodiments, the substrate floats due to an entrapped or entrained layer of gas (e.g. air, crankcase gases, and the like), but sinks at least partially when exposed to a partial vacuum. In certain embodiments, the substrate sinks to a depth consistent with no entrapped air—which does not mean that the substrate completely submerges except in the case where the substrate has a greater density than the buoyant liquid.

In certain embodiments, the micro-protrusions are formed by vacuum or air plasma treatment, and/or nanoparticles applied to the surface. In certain embodiments, the wettability patch pattern is formed by a process including vacuum or air plasma treatment with a gas including a non-wetting material (e.g., fluorocarbons), chemical addition of a non-wetting material to the polymer material, surface coating with a non-wetting material, and treating the substrate with a solution comprising a non-wetting material dissolved in a solvent and removing the solvent. In certain embodiments, the non-wetting material includes a fluorocarbon, siloxane, and/or a surfactant including an agent that is a non-wetting agent with respect to the dispersed phase. In certain embodiments, the micro-protrusions and the wettability patch pattern are formed by similar manufacturing steps or even in a single manufacturing step (e.g., deposition of fluorocarbon microparticles which form the wettability patch pattern and the micro-protrusions in a single manufacturing step).

In certain embodiments, the substrate is a portion of a filtering element for at a coalescing crankcase filter, including an open crankcase filter and/or a closed crankcase filter.

In certain embodiments, a method includes manufacturing a filtration medium as described herein. In certain embodiments, the filtration medium is at least a portion of a crankcase filter for an engine. In certain embodiments, the crankcase filter exhibits an efficiency greater than about 85% with respect to the dispersed phase (i.e., at least about 85% of dispersed phase mass is removed), and exhibits a final pressure drop at saturation of less than about 5 inches of water. In certain embodiments, the efficiency of the crankcase filter can be much higher—for example in the mid-90% or higher range.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus ≦10% of the particular term and “substantially” and “significantly” will mean plus or minus >10% of the particular term.

In the foregoing description, certain terms have been used for brevity, clearness, and understanding. No unnecessary limitations are to be implied therefrom beyond the requirement of the prior art because such terms are used for descriptive purposes and are intended to be broadly construed. The different configurations, systems and method steps described herein may be used alone or in combination with other configurations, systems and method steps. It is to be expected that various equivalents, alternatives and modifications are possible.

Citations to a number of non-patent references are made herein. The cited references are incorporated by reference herein in their entireties. In the event that there is an inconsistency between a definition of a term in the specification as compared to a definition of the term in a cited reference, the term should be interpreted based on the definition in the specification.

1. A coalescing media for coalescing a mixture of two immiscible phases, namely a continuous phase and a dispersed liquid phase, wherein the media is configured for capturing droplets of the dispersed phase and coalescingly growing the droplets into larger drops which grow to a sufficient size whereby they are released from the media, the media comprising a polymeric base material having a heterogeneous surface comprising asperities wherein a preponderance of the heterogeneous surface is non-wetting with respect to the dispersed liquid phase, the media configured for capturing droplets of the dispersed liquid phase wherein a layer of air is trapped at the heterogeneous surface and tips of the asperities extend through the trapped layer and contact the droplets.

2. The media of claim 1, wherein the continuous phase is a continuous gas phase, the layer of air comprises the continuous gas phase, and the dispersed liquid phase is comprised mainly of hydrocarbon liquid.

3. The media of claim 1, wherein the polymeric base material comprises a plurality of polymeric fibers selected from a group consisting of polyester, nylon, fluorocarbon, polypropylene, polyphenylene sulfide, polyurethane, aramid, and mixtures thereof.

4. The media of claim 1, wherein the media is configured such that a drop of the dispersed phase settled on the heterogenous surface forms a first contact angle χ from the surface, wherein χ comprises a value greater than about 60°.

5. The media of claim 4, wherein χ comprises a value greater than about 90°.

6. The media of claim 1, wherein the media is configured such that a droplet of the dispersed phase settled on the heterogenous surface form a second contact angle θ, wherein θ comprises a value greater than about 45°.

7. The media of claim 1, wherein θ comprises a value greater than about 90°.

8. The media of claim 1, wherein the media exhibits a normalized sine α value less than a critical value for oil.

9. The media of claim 8, wherein the normalized sine α is defined as sin αₙₒᵣₘ=sin αm^{2/3}ρ^{1/3}g, wherein sin α is defined as
$$sin α = \frac{2 Rk sin χ ( cos χ + 1 )}{g ( R cos θ + 1 )} \sqrt[3]{\frac{3 {π}^{2}}{{m}^{2} ρ ( 2 - 3 cos χ + {cos}^{3} χ )}} ,$$
wherein R is a roughness factor, k is a constant, χ is a first contact angle, θ is a second contact angle, g is acceleration due to gravity, m is a representative droplet mass, and ρ is a representative droplet density.

10. The media of claim 8, wherein the sin αₙₒᵣₘ is less than about 72 g/s².

11. The media of claim 8, wherein α is determined by placing a drop of dispersed phase on a horizontal sample of the coalescer media and the tilt or angle of elevation of the media is gradually changed until the drop begins to move.

12. The media of claim 1, wherein the media floats in the dispersed phase.

13. The media of claim 11, wherein the media sinks at least partially in the dispersed phase when exposed to at least a partial vacuum.

14. The media of claim 1, wherein the asperities are formed by a process selected from the processes consisting of vacuum plasma treatment, air plasma treatment, nanoparticles applied to the surface, chemical etching, and combinations thereof.

15. The media of claim 1, wherein the heterogenous surface is formed by subjecting the polymeric base material to a process selected from a group consisting of vacuum plasma treatment with a gas including a non-wetting material, air plasma treatment with a gas including a non-wetting material, chemical addition of a non-wetting material to the base polymeric material, surface coating of the base polymeric material with a non-wetting material, and treating the base polymeric material with a solution comprising a non-wetting material dissolved in a solvent and removing the solvent, and combinations thereof.

16. The media of claim 1, wherein the base polymeric material is relatively non-wetting with respect to the liquid dispersed phase.

17. The media of claim 1, wherein the media comprises at least one material selected from a group consisting of a fluorocarbon, a siloxane, and a surfactant comprising an agent that is a non-wetting agent with respect to the dispersed phase at the heterogeneous surface.

18. The media of claim 1, wherein the media is configured for use in a crankcase coalescing filter for an engine.

19. The media of claim 1, wherein θ is greater than 45°.

20. The media of claim 1, wherein θ is greater than 90° and contact angle hysteresis is greater than 5°.

21. The media of claim 1, wherein χ is greater than 90° and contact angle hysteresis is greater than 5°.

22. The media of claim 1, wherein θ is greater than 90° and surface area ratio is greater than 2.65.

23. The media of claim 1, wherein χ is greater than 90° and surface area ratio is greater than 2.65.

24. The media of claim 1, wherein normalized sine α is less than 72 g/s².

25. The coalescing media of claim 1, wherein the continuous phase is a continuous gas phase, the layer of trapped air comprises the continuous gas phase, and the dispersed liquid phase is comprised mainly of water.

26. The media of claim 25, wherein the media exhibits a normalized sine α value less than a critical value for water.

27. The media of claim 25, wherein normalized sine α is less than 84 g/s².

28. The coalescing media of claim 1, wherein the continuous phase is a continuous liquid phase, and the dispersed liquid phase is comprised mainly of hydrocarbon material.

29. The coalescing media of claim 1, wherein the continuous phase is a continuous liquid phase, and the dispersed liquid phase is comprised mainly of water.

30. A method for manufacturing the coalescing media of claim 1, the method comprising: (a) providing the polymeric base material having a heterogeneous surface comprising asperities wherein a preponderance of the heterogeneous surface is hydrophilic; and (b) soaking the polymeric base material having a heterogeneous surface comprising asperities in a liquid comprised mainly of hydrocarbon material, wherein a layer of air is trapped at the heterogeneous surface and tips of the asperities extend through the trapped layer and contact the liquid.

31. The method of claim 30, wherein the polymeric base material having a heterogeneous surface comprising asperities is prepared by subjecting the polymeric base material to a process selected from a group consisting of vacuum plasma treatment with a gas including a hydrophilic material, air plasma treatment with a gas including a hydrophilic material, chemical addition of a hydrophilic material to the base polymeric material, surface coating of the base polymeric material with a hydrophilic material, and treating the base polymeric material with a solution comprising a hydrophilic material dissolved in a solvent and removing the solvent, and combinations thereof.

32. The method of claim 30, further comprising manufacturing the filtration medium as a crankcase filter element, such that the crankcase filter element exhibits an efficiency greater than 85% with respect to the dispersed phase, and exhibits a final saturated pressure drop of less than about 5 inches of water.

33. A coalescing element comprising the coalescing media according to claim 1.

34. The coalescing element of claim 33, wherein the coalescing media is contained in a housing, the housing having an upstream inlet structured to receive the mixture and a downstream outlet structured to discharge the mixture after coalescing of the dispersed phase.

35. A coalescing system comprising the coalescing element according to claim 33.

36. A method of removing a dispersed phase comprising hydrocarbon liquid, water, or a mixture thereof dispersed in a continuous gas phase, the method comprising passing the continuous phase through the coalescing media of claim 1, wherein the system removes at least about 93% of the dispersed phase from the continuous phase.

37. The method according to claim 36, wherein the method removes at least about 96% of the dispersed phase from the continuous phase.

38. The method according to claim 36, wherein the method removes at least about 99% of the dispersed phase from the continuous phase.
